(19) United States
(12) Patent Application Publication
(10) Pub. No.: US 2026/0140764 A1
(43) Pub. Date: May 21, 2026

(54) FINE-GRAINED PREEMPTION OF A DATA FLOW ARCHITECTURE BASED NEURAL PROCESSING UNIT

(71) Applicants: Advanced Micro Devices, Inc., Santa Clara, CA (US); Xilinx, Inc., San Jose, CA (US)

(72) Inventors: Sonal Santan, San Jose, CA (US); Vinod K. Kathail, Palo Alto, CA (US); Yu Liu, Newark, CA (US); Huazhuo Xu, San Jose, CA (US); Cheng Zhen, San Jose, CA (US); Nishad Nandkishor Saraf, San Jose, CA (US); Satish Rangarajan, Bangalore (IN); Pranjal Joshi, San Jose, CA (US); Javier Cabezas Rodriguez, Austin, TX (US); Shanthanand Kutuva Rabindranath, Folsom, CA (US)

(73) Assignees: Advanced Micro Devices, Inc., Santa Clara, CA (US); Xilinx, Inc., San Jose, CA (US)

(21) Appl. No.: 18/954,075

(22) Filed: Nov. 20, 2024

(51) Int. Cl. G06F 9/48; G06F 9/30; G06F 9/46

(52) U.S. Cl. CPC G06F 9/4881; G06F 9/30043; G06F 9/461

(57) ABSTRACT

Fine-grained preemption of a data flow architecture based neural processing unit (NPU) includes executing, by a controller, control-code that implements a first context in the NPU. In response to the controller detecting a preemption opcode in the control-code, detecting, by the controller, a second context awaiting execution by the neural processing unit. The second context has a priority that is greater than a priority of the first context. In response to detecting the second context, the NPU switches from executing the first context to implementing the second context.

### TECHNICAL FIELD

This disclosure relates to integrated circuits (ICs) and, more particularly, to preempting operating contexts of a Neural Processing Unit that utilizes a data flow architecture.

### BACKGROUND

A neural processing unit is a variety of integrated circuit (IC) typically implemented as one or more computer microprocessors capable of mimicking certain processing functions of the human brain. An NPU is often optimized for performing or executing artificial intelligence (AI) neural networks, deep learning, and/or machine learning tasks and applications. NPUs are considered different or distinct from general-purpose central processing units (CPUs) or graphics processing units (GPUs) in that NPUs may be architected to accelerate AI tasks and workloads, such as calculating neural network layers that require scalar, vector, and/or tensor math operations.

Some varieties NPUs include one or more data processing arrays. The NPU provides significant computational power and a high degree of parallelism. The applications intended to execute using an NPU, e.g., AI and/or machine learning applications, are often implemented using a data flow model of computation. Data flow models of computation focus on data production and data consumption between computational nodes in a data flow graph often used to specify the application. Typically, each different set of computations, or layers, of an application that is executed by an NPU may be referred to as an “operating context” or “context.”

At runtime, the NPU may be required to switch among these different contexts to execute different layers or portions of the larger application. The NPU, for example, may be required to discontinue one context prior to completing execution of that context and start or resume another, different context. In some cases, however, the NPU hardware itself is modeled after the data flow architecture. An NPU implemented using a data flow hardware architecture may be capable of providing deterministic performance, but lacks hardware interrupt mechanisms used to preempt execution of a currently executing context to start execution of another context as would typically be the case with a general purpose CPU.

### SUMMARY

In one or more embodiments, a method includes executing, by a controller, control-code that implements a first context in a neural processing unit (NPU). The method includes, in response to the controller detecting a preemption opcode in the control-code, detecting, by the controller, a second context awaiting execution by the NPU and that a priority of the second context is greater than a priority of the first context. The method includes, in response to the detecting of the second context, switching, by the controller, the NPU from the first context to the second context.

The foregoing and other implementations can each optionally include one or more of the following features, alone or in combination. Some example implementations include all the following features in combination.

In some aspects, the preemption opcode is located within the control-code at a location in which compute tiles of the NPU are in a quiescent state.

In some aspects, the preemption opcode is located between two consecutive layers of the first context.

In some aspects, the switching from the first context to the second context includes saving a state of the first context by saving a value of a program counter of the controller and saving content from a memory of the NPU.

In some aspects, with respect to saving state, the memory of the NPU includes one or more memory tiles. In other aspects, with respect to saving state, the memory of the NPU includes one or more memory tiles and one or more data memories of one or more compute tiles.

In some aspects, the switching from the first context to the second context includes restoring a state of the second context by loading an NPU binary for the second context into compute tiles of the NPU, loading saved content for the second context into the memory of the NPU, loading a saved program counter value for the second context into the program counter of the controller, loading control-code for the second context in a program memory of the controller, and continuing execution of the control-code for the second context from a location specified by the saved program counter value.

In some aspects, the loading the saved content into the memory of the NPU includes loading saved content into one or more memory tiles. In other aspects, the loading the saved content into the memory of the NPU includes loading saved content into one or more memory tiles and one or more data memories of one or more compute tiles.

In some aspects, the method includes comparing the priority of the first context with the priority of the second context.

In some aspects, the NPU is implemented using a data flow architecture to provide deterministic performance.

In one or more embodiments, a system includes an NPU and a controller coupled to the NPU. The controller is capable of executing control-code that implements a first context in the NPU. The controller, in response to detecting a preemption opcode in the control-code, is capable of detecting a second context awaiting execution by the NPU and that a priority of the second context is greater than a priority of the first context. In response to the detecting, the controller is capable of switching the NPU from the first context to the second context.

The foregoing and other implementations can each optionally include one or more of the following features, alone or in combination. Some example implementations include all the following features in combination.

In some aspects, in response to detecting that no other context having a higher priority than the priority of the first context is awaiting execution by the NPU, the controller continues execution of the first context.

In some aspects, the preemption opcode is located within the control-code at a location in which compute tiles of the NPU are in a quiescent state.

In some aspects, the preemption opcode is located between two consecutive layers of the first context.

In some aspects, the controller is capable of switching from the first context to the second context by saving a state of the first context by saving a value of a program counter of the controller and saving content from a memory of the NPU.

In some aspects, with respect to saving state, the memory of the NPU includes one or more memory tiles. In other aspects, with respect to saving state, the memory of the NPU includes one or more memory tiles and one or more data memories of one or more compute tiles.

In some aspects, the switching from the first context to the second context includes restoring a state of the second context by loading saved content for the second context into the memory of the NPU, loading a saved program counter value for the second context into the program counter of the controller, loading configuration data for the second context into compute tiles of the NPU, loading control-code for the second context in a program memory of the controller, and continuing execution of the control-code for the second context from a location specified by the saved program counter value.

In some aspects, the loading the saved content into the memory of the NPU includes loading saved content into one or more memory tiles.

In some aspects, the memory of the NPU includes one or more memory tiles. In other aspects, the memory of the NPU includes one or more memory tiles and one or more data memories of one or more compute tiles.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The accompanying drawings show one or more embodiments of the disclosed technology. The drawings, however, should not be construed to be limiting of the inventive arrangements to only the embodiments shown. Various aspects and advantages will become apparent upon review of the following detailed description and upon reference to the drawings.

FIG. 1 illustrates a computing system capable of context preemption in accordance with one or more embodiments of the disclosed technology.

FIG. 2 illustrates a neural processing unit (NPU) in accordance with one or more embodiments of the disclosed technology.

FIG. 3 illustrates insertion of preemption opcodes into control-code in accordance with one or more embodiments of the disclosed technology.

FIG. 4 illustrates a method of inserting preemption opcodes into control-code in accordance with one or more embodiments of the disclosed technology.

FIG. 5 illustrates a method of preemption of contexts executed by an NPU in accordance with one or more embodiments of the disclosed technology.

FIG. 6 illustrates certain operative features of preempting contexts in accordance with one or more embodiments of the disclosed technology.

FIG. 7 illustrates another method of preemption of contexts executed by an NPU in accordance with one or more embodiments of the disclosed technology.

FIG. 8 illustrates another implementation of a hardware accelerator in accordance with one or more embodiments of the disclosed technology.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to integrated circuits (ICs) and, more particularly, to preempting operation of a neural processing unit (NPU) that utilizes a data flow architecture. An NPU implemented using a data flow hardware architecture typically provides deterministic performance. The deterministic performance is often achieved by omitting hardware interrupt mechanisms typically used to preempt (e.g., interrupt) execution of currently executing tasks. In such cases, in order to switch the context executed by the NPU, the NPU must first complete execution of the current context before executing or starting a different context. In other words, the current context executed by the NPU may not be preempted to begin execution of a different context.

Typically, each different set of computations, or layers, of an application that is executed by an NPU may be referred to as a “context.” An example of a context may be ResNet50, e.g., a deep neural network architecture, while another context may include Generalized Mean Pooling (GEM). The NPU may require some degree of reconfiguration to switch between these two contexts.

In accordance with the inventive arrangements described within this disclosure, methods, systems, and computer program products are disclosed that facilitate preemption of an NPU implemented with a data flow architecture. The embodiments disclosed herein implement a software-based solution that provides fine-grain control over preempting contexts executed by an NPU. This enables the NPU to execute multiple contexts concurrently. Each context, for example, may continue to make progress in accomplishing its computational task based on the priority of that context. In one or more embodiments, one or more special purpose opcodes may be inserted into control-code of a controller that is capable of controlling operation of the NPU. The special purpose opcodes, referred to as preemption opcodes, may be incorporated into the control-code by a compiler.

The controller executes the control-code to control operation of the NPU. Accordingly, while executing the control-code and causing the NPU to execute a given context, the controller may encounter or detect a preemption opcode. In response to detecting a preemption opcode, the controller checks whether any other contexts are waiting to execute that have a higher priority than the context currently executing. In response to detecting that a higher priority context is awaiting execution, the controller causes the NPU to begin execution of the higher priority context. Otherwise, the controller causes the NPU to continue execution of the current context. Appreciably, the controller is capable of storing any relevant or needed state information for any context that is preempted so that the preempted context may be restarted at a later time.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

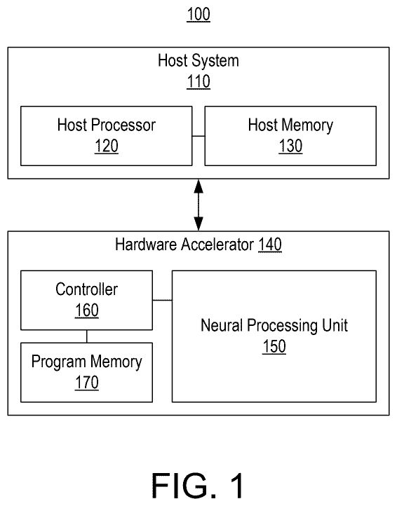

FIG. 1 illustrates a computing system (system) 100. System 100 includes a host system 110 and a hardware accelerator 140. Host system 110 includes a host processor 120 and a host memory 130. Hardware accelerator 140 includes an NPU 150, a controller 160, and program memory 170.

Referring to host system 110, host processor 120 may be implemented in hardware and may be implemented as one or more hardware processors. Host processor 120 may be implemented as one or more circuits capable of executing computer-readable program instructions (program instructions). The circuit(s) may comprise integrated circuits (ICs) or may be embedded within an IC. In one or more examples, host processor 120 may be embodied as a central processing unit (CPU). Host processor 120 may include one or more cores, for example, where each core is capable of executing computer-readable program instructions.

For purposes of illustration and not limitation, host processor 120 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like.

Host memory 130 may be embodied as one or more computer-readable storage mediums. In the example, host memory 130 may include, or be implemented as, volatile memory such as random-access memory (RAM). For example, host memory 130 may be implemented as a Double Data Rate, Synchronous Dynamic Random Access Memory or “DDR memory.” In one or more other examples, host memory 130 may be implemented as a high-bandwidth memory. Host memory 130, for example, may be referred to as “runtime memory” of host system 110. In one or more embodiments, host memory 130 may be accessed by host processor 120 and/or one or more components and/or systems of hardware accelerator 140.

Host system 110 may include one or more other components and/or subsystems not illustrated in FIG. 1 including, but not limited to, a non-volatile memory, one or more input/output interfaces, and a communication bus or interconnect circuitry that couples the various elements of host system 110. The non-volatile memory may include a non-volatile magnetic medium and/or a non-volatile solid-state medium (typically called a “hard drive”). The non-volatile memory may include one or more disk drives capable of reading from and writing to various types of removable, non-volatile mediums such as a removable, non-volatile magnetic disk (e.g., a “floppy disk”) and/or a removable, non-volatile optical disk such as a CD-ROM, DVD-ROM or other optical media.

Host memory 130 is capable of storing program instructions and/or data such that host processor 120 is capable of executing the program instructions to perform one or more operations as described within this disclosure. For example, the program instructions can include an operating system, one or more application programs, other program code, and program data. Host processor 120, in executing the computer-readable program instructions, is capable of performing the various operations described herein that are attributable to a computer. For example, host processor may execute an application that causes or invokes one or more different contexts to be executed over time by hardware accelerator 140.

In the example, host processor 120 is coupled to hardware accelerator 140. Host processor 120 may be coupled to hardware accelerator 140 by way of the communication bus, interconnect circuitry, or other communication channel (not shown).

In one or more embodiments, NPU 150 is implemented as a data processing array. NPU 150 may be implemented as a plurality of hardwired circuit blocks. The plurality of circuit blocks may be programmable. NPU 150 may include a plurality of compute tiles, one or more memory tiles, and a plurality of interface tiles organized in an array interface. Controller 160 may be implemented as a processor, e.g., one or more circuits or hardware, capable of executing program code. Controller 160 is capable of controlling operation of NPU 150 to implement one or more operations of a deep neural network or machine learning model, e.g., one or more different contexts. The different contexts executed by NPU 150 under control of controller 160 may be invoked by host processor 120 executing an application.

Program memory 170 may represent any of a variety of on-chip RAM memories. Examples of program memory 170 may include a Synchronous Dynamic Random Access Memory (SDRAM). Program memory 170 is capable of storing program code, e.g., firmware and/or control-code, that is executable by controller 160. In one or more example implementations, NPU 150 may be coupled to additional RAM (not shown) such as DRAM. Such DRAM may be located off-chip relative to hardware accelerator 140 and/or NPU 150.

In one or more embodiments, system 100 may be implemented as a computer system including a hardware accelerator where host system 110 is implemented as a computer or server while hardware accelerator 140 is implemented as an IC disposed on a card or as part of a peripheral device coupled to the computer or server.

In one or more other embodiments, system 100 may be implemented as any of a variety of different types of ICs including, but not limited to, a programmable IC, an adaptive system, and/or a System-on-Chip (SoC). For example, system 100 may be implemented as a single or same die. Alternatively, system 100 may be implemented as a plurality of interconnected dies (e.g., chiplets) within a same package. The particular physical implementation of system 100 is not intended as a limitation of the inventive arrangements described within this disclosure.

In the example of FIG. 1, host processor 120 is capable of executing a runtime stack that may include a driver. Control-code may be executing on controller 160 of hardware accelerator 140. Hardware accelerator 140 may orchestrate the preemption of contexts being executed or implemented by NPU 150. In one or more embodiments, contexts (e.g., each context) running on NPU 150, or a portion of NPU 150 such as a partition that includes only a subset of the available tiles of NPU 150, may include well-defined preemption points in the control-code that is executed by controller 160. The preemption points may be inserted by a compiler as described in greater detail hereinbelow. In general, the control-code refers to a compiler generated, application-specific fragment of executable program code that can be executed by firmware running on controller 160.

Hardware accelerator 140 executes different contexts at the request or command of host processor 120. In requesting a context be executed, host processor 120 is capable of assigning each such context a priority. In this manner, host processor 120 is capable of dictating which context may preempt execution of another by assigning such context a higher priority than a context currently executed by hardware accelerator 140. In addition, host processor 120 is capable of dynamically changing a priority of a context during runtime. For example, host processor 120 may update or modify (e.g., increase or decrease) a priority of a context that is awaiting execution or that has been preempted. The control-code executed by controller 160 honors the relative priority of all live contexts as updated by host processor 120.

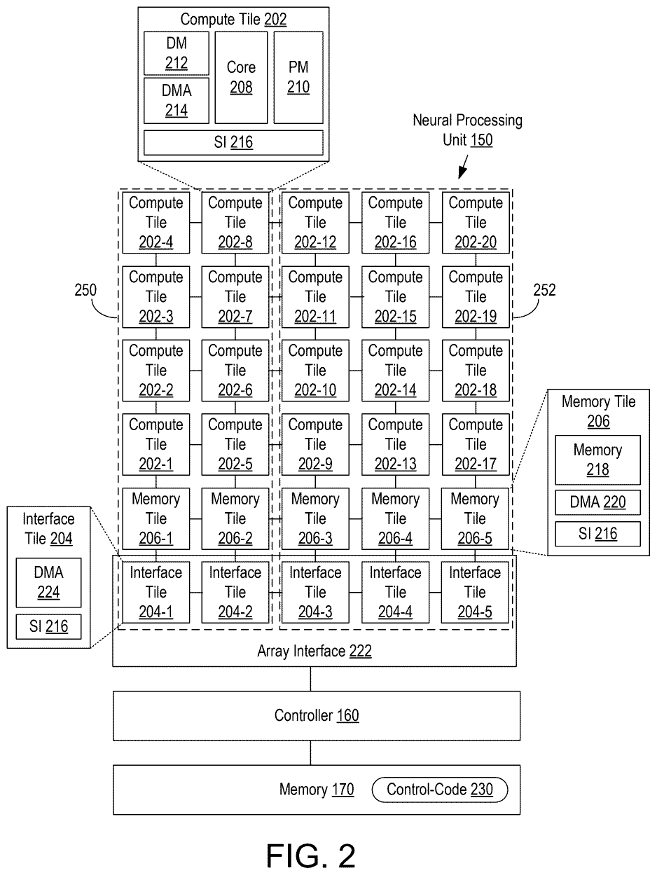

FIG. 2 illustrates an NPU 150 in accordance with one or more embodiments of the disclosed technology. In the example, NPU 150 is implemented as a data processing array including a plurality of interconnected tiles. The term “tile,” as used herein in connection with a data processing array such as NPU 150, means a circuit block. The interconnected tiles of NPU 150 include compute tiles 202, interface tiles 204, and memory tiles 206. The tiles illustrated in FIG. 2 may be arranged in an array or grid and are hardwired.

Each compute tile 202 can include one or more cores 208, a program memory (PM) 210, a data memory (DM) 212, a DMA circuit 214, and a stream interconnect (SI) 216. In one aspect, each core 208 is capable of executing program code stored program memory 210. In one aspect, each core 208 may be implemented as a scalar processor, as a vector processor, or as a scalar processor and a vector processor operating in coordination with one another. Compute tiles 202 implement the computational capabilities of NPU 150.

In one or more examples, each core 208 is capable of directly accessing the data memory 212 within the same compute tile 202 and the data memory 212 of any other compute tile 202 that is adjacent to the core 208 of the compute tile 202 in the up, down, left, and/or right directions. Core 208 sees data memories 212 within the same tile and in one or more other adjacent compute tiles as a unified region of memory (e.g., as a part of the local memory of the core 208). This facilitates data sharing among different compute tiles 202 in NPU 150. In other examples, core 208 may be directly connected to data memories 212 in other compute tiles 202.

Cores 208 may be directly connected with adjacent cores 208 via core-to-core cascade connections (not shown). In one aspect, core-to-core cascade connections are unidirectional and direct connections between cores 208. In another aspect, core-to-core cascade connections are bidirectional and direct connections between cores 208. In general, core-to-core cascade connections generally allow the results stored in an accumulation register of a source core 208 to be provided directly to an input of a target or load core 208 bypassing, e.g., without traversing, the stream interconnect 216 (e.g., without using DMA circuit 214) and bypassing data memory, e.g., without being written by a first core 208 to data memory 212 to be read by a different core 208.

In an example implementation, compute tiles 202 do not include cache memories. More particularly, the memories illustrated in NPU 150 do not have “hit” or “miss” mechanisms. Data that is used by any given compute tile 202, for example, is expected to be at the location or in the particular memory accessed. By omitting cache memories (e.g., the hit/miss mechanisms that characterize a cache), NPU 150 is capable of achieving predictable, e.g., deterministic, performance. Further, significant processing overhead is avoided since maintaining coherency among cache memories located in different compute tiles 202 is not required. Also, because NPU 150 implements a data flow architecture capable of providing deterministic performance, cores 208 do not have input interrupts. In one or more embodiments, none of tiles 202, 204, and/or 206 have input interrupts. Thus, cores 208 are capable of operating uninterrupted. Omitting input interrupts to cores 208 and/or the tiles 202, 204, and 206 in general also allows NPU 150 to achieve predictable, e.g., deterministic, performance. As discussed, without inclusion of interrupts, operation of NPU 150 may not be interrupted via a hardware mechanism.

Memory tiles 206 include a memory 218 (e.g., a RAM), a DMA circuit 220, and a stream interconnect 216. Each memory tile 206 may read and/or write to the memory 218 of an adjacent memory tile 206 by way of the DMA circuit 220 included in the memory tile 206. Further, each compute tile 202 in NPU 150 is capable of reading and writing to any one or more of memory tiles 206. Memory tiles 206 are characterized by the lack of computational components such as processors (e.g., cores 208).

Interface tiles 204 form an array interface 222 for NPU 150. Array interface 222 operates as an interface that connects tiles of NPU 150 to other resources of the particular IC in which NPU 150 is disposed. In the example of FIG. 2, array interface 222 includes a plurality of interface tiles 204 organized in a row. Interface tiles 204 can include a stream interconnect 216 and a DMA circuit 224. Interface tiles 204 are connected so that data may be propagated from one interface tile to another bi-directionally. Each interface tile 204 is capable of operating as an interface for the column of tiles directly above and is capable of interfacing such tiles with components and/or subsystems of the IC including NPU 150.

In one or more embodiments, hardware accelerator 140 may include one or more other subsystems (not shown). For example, hardware accelerator 140 may include one or more or each of subsystems including, but not limited to, programmable logic, a processor system, a Network-on-Chip, a platform management controller, and one or more hardwired circuit blocks.

In one or more embodiments, NPU 150 may be partitioned into a plurality of partitions. In the example, partitions 250 and 252 are formed. Each partition is capable of operating independently of the other. More particularly, each partition may execute a different computing task (e.g., context) independently of the other. As an example, the various stream switches and DMA circuits of NPU 150 may be configured to avoid sharing data across partition boundaries.

In one or more embodiments, state information for a context executed by NPU 150 may be fully encapsulated in the particular memory tiles 206 used to execute the context. In general, controller 160 implements a context by moving data from a global memory (not shown), into memory tiles 206, and then into the respective compute tiles 202 for performing computations. Data generated by operation of compute tiles 202 may be stored in data memories 212 and/or in memory tiles 206.

Preemption of a context may be permitted only at points where NPU 150 is in a quiescent state. In one or more embodiments, the quiescent state may only need to exist for the compute tiles 202 of NPU 150 executing the context. For example, preemption of a context (e.g., switching from one context to another) may be performed only at particular locations and/or times.

In one or more embodiments, these locations correspond to Task Complete Tokens (TCTs). A TCT indicates a boundary may be marked by a compiler and typically occur at the end of a layer for a given context. By allowing preemption only at point where NPU 150 is in a quiescent state, state information for NPU 150 is limited to being only within, or entirely encapsulated in, memory tiles 206. Any results generated by compute tiles 202 have been moved to memory tiles 206 or have already been moved to global memory. Thus, state information for the context is not included or stored in compute tiles 202 or in interface tiles 204.

This quiescent state condition for preemption prevents data loss when switching contexts in NPU 150 and further results in only a limited amount of state information needing to be stored for use when the preempted context is later restored. The state information may include any data stored in a memory tile 206. In this embodiment, only data stored in memory tiles 206 need be restored to resume execution of a preempted context. Such is the case as the preemption opcodes inserted into control-code 230 as executed by controller 160 may be inserted therein by the compiler only at particular locations corresponding to TCT boundaries.

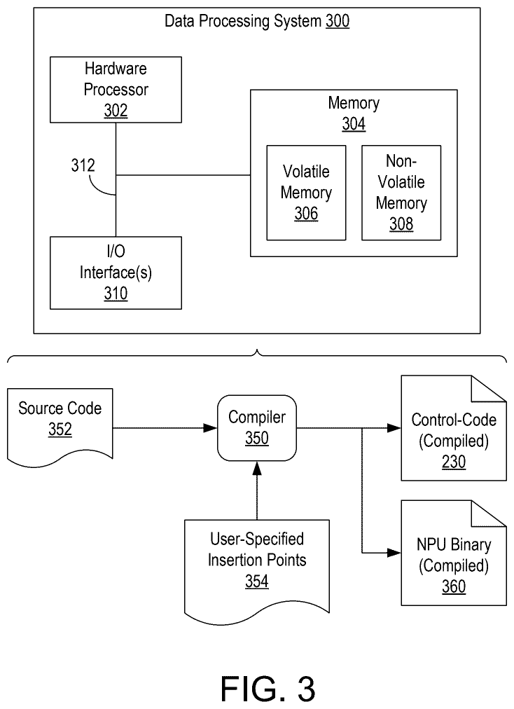

FIG. 3 illustrates insertion of preemption opcodes into control-code 230 in accordance with one or more embodiments of the disclosed technology. In the example of FIG. 3, a data processing system 300 is illustrated executing a compiler 350. As used herein, “data processing system” refers to one or more hardware systems capable of processing data. Each hardware system may include one or more hardware processors and memory. In the example, data processing system 300 includes a hardware processor 302, a memory 304, input/output (I/O) interfaces 310, and a communication bus 312 that couples hardware processor 302, memory 304, and I/O interfaces 310.

In the example, hardware processor 302 may be implemented as described in connection with host processor 120 of FIG. 1. Memory 304 may be embodied as one or more computer-readable storage mediums. Memory 304 may include a volatile memory 306 and a non-volatile memory 308. Volatile memory 306 may be embodied as random-access memory (RAM) and may include cache memory. Volatile memory 306 may be referred to as “runtime memory.” Non-volatile memory 308 may include a non-volatile magnetic medium and/or a solid-state medium (typically called a “hard drive”). Non-volatile memory 308 also may include one or more disk drives capable of reading from and writing to various types of removable, non-volatile mediums such as a removable, non-volatile magnetic disk (e.g., a “floppy disk”) and/or a removable, non-volatile optical disk such as a CD-ROM, DVD-ROM or other optical media.

Memory 304 is capable of storing program instructions and/or data such that hardware processor 302 is capable of executing the program instructions to perform one or more operations as described within this disclosure. For example, the program instructions can include an operating system, one or more application programs such as compiler 350, other program code, and program data. Hardware processor 302, in executing the computer-readable program instructions, is capable of performing the various operations described herein that are attributable to a computer such as compiling source code 352, which may specify a data flow graph for an application.

Data processing system 300 includes I/O interface(s) 310. I/O interfaces 310 allow data processing system 300 to communicate with one or more external devices and/or communicate over one or more networks such as a local area network (LAN), a wide area network (WAN), and/or a public network (e.g., the Internet). Examples of I/O interfaces 310 may include, but are not limited to, network cards, modems, network adapters (wired and/or wireless), hardware controllers, etc. Examples of external devices also may include devices that allow a user to interact with data processing system 300 (e.g., a display, a keyboard, and/or a pointing device) and/or other devices such as accelerator card.

Data processing system 300 includes a communication bus 312 represents one or more of any of a variety of communication bus structures. By way of example, and not limitation, communication bus 312 may be implemented as a Peripheral Component Interconnect Express (PCIe) bus. Communication bus 312 couples to each of hardware processor 302, memory 304, and I/O interface(s) 310 through respective interface circuitry thereby allowing the devices to communicate. Communication bus 312 may represent a plurality of buses that may be interconnected and/or hierarchically organized.

Data processing system 300 is only one example implementation. Data processing system 300 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices. Data processing system 300 is an example of computer hardware that is capable of performing the various operations described within this disclosure.

Data processing system 300 is provided for purposes of illustration. In one or more embodiments, host system 100 may execute compiler 350 and perform the operations attributed to data processing system 300. In one or more embodiments, host system 100 may perform compilation operation at runtime while or “on-the-fly” while hardware accelerator 140 is operating and/or while NPU 150 is executing one or more contexts.

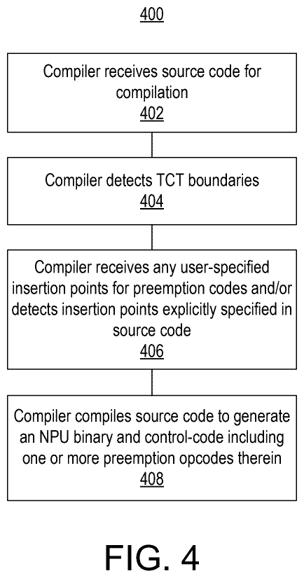

FIG. 4 illustrates a method 400 of inserting preemption opcodes into control-code 230 in accordance with one or more embodiments of the disclosed technology. Method 400 may be performed by compiler 350 as executed by data processing system 300 or host system 100. Referring to FIGS. 3 and 4, in block 402, compiler 350 receives source code 352. Source code 352, as noted, may specify a data flow graph corresponding to an AI or machine learning application. In general, source code 352 may be compiled into configuration data for NPU 150 and control-code for controller 160. In the example, compiler 350 is capable of compiling source code 352 into a plurality of binary files illustrated as control-code 230 and an NPU binary 360. Taken collectively, control-code 230 and NPU binary 360 may represent a programmable device image (PDI) for hardware accelerator 140. In general, control-code 230 is executable by controller 160 to control operation of NPU 150 and NPU binary 360 is executable by the compute tiles 202 of NPU 150. Compiler 350 also may generate application code that is executable by host processor 120 (not shown).

In block 404, in one or more embodiments, compiler 350 is capable of detecting one or more TCT boundaries within source code 352. In one or more embodiments, each TCT boundary may correspond to a particular layer, or boundary between successive layers, of source code 352. For example, source code 352 may specify an implementation of a machine learning model that includes one or more, e.g., a plurality, of different layers. Compiler 350 is capable of detecting the boundary between successive or consecutive layers in source code 352.

In one or more embodiments, a TCT indicates completion of a DMA operation between host memory 130 and a memory tile 206. A context on NPU 150 maps to one application process on host processor 120. The context is created once by the application and used to process all inferencing commands from the application in NPU 150. Each inferencing command has a control-code buffer where preemption points are inserted. The quiescent state refers to an entire context in reference to compute tiles 202, memory tiles 206, and interface tiles 204 including DMA circuits of the respective tiles to ensure that state of NPU 150, or partition of NPU 150, executing a context, is encapsulated in memory tiles 206.

In block 406, source code 352 is capable of receiving any user-specified insertion points 354 for inserting preemption opcodes into control-code 230. For example, the user may provide input in the form of a file or via command line specifying one or more insertion points in source code 352 at which preemption codes are to be inserted. Also in block 406, compiler 350 is capable of detecting any explicitly specified insertion points for preemption opcodes that may have been explicitly included, or coded, into source code 352.

In the example of FIG. 4, one or more portions or the entirety of block 406 may be optional (e.g., omitted). For example, the receipt of user specified insertion points and/or the detection of explicitly enumerated insertion points may be omitted. In still other embodiments, if insertion points are specified via one or more of the mechanisms outlined in block 406, block 404 may be omitted. In still other embodiments, whether block 404 and/or portions or the entirety of block 406 is omitted may be specified in a configuration file and/or setting of compiler 350.

In block 408, compiler 350 is capable of compiling source code 352 to generate control-code 230 and NPU binary 360. Control-code 230, as compiled, includes one or more preemption opcodes included therein. The preemption opcodes are incorporated or inserted into control-code 230 at any user-specified insertion point 354 and/or at one or more TCT boundaries as part of the compilation operation performed by compiler 350. For example, preemption opcodes may be inserted between two consecutive layers of a context. The preemption opcodes are low overhead control-codes.

In one or more embodiments, in inserting preemption opcodes into control-code 230, compiler 350 is capable of deciding the interval, e.g., time, between successive preemption opcodes. The time may be specified as a user-specified setting or preference. This means that the compilation process dictates how frequently controller 160, within the constraints of quiescent states of NPU 150, checks for preemption of the currently executing context. The interval may be a configurable property of compiler 350 so that the interval may be adjustable or tunable for different preferences and/or applications. For example, a preference may be to insert a preemption opcode at each quiescent state or every N quiescent states (e.g., where N is an integer value). In one or more embodiments, preemption opcodes may be inserted into control-code 230 such that contexts may be switched at predetermined intervals. For example, quiescent states may occur frequently enough so that context switching (e.g., the insertion of a preemption opcode) provides the capability of context switching every M millisecond(s), where M is an integer value such as 1. This process provides deterministic performance with respect to preemption in that preemption may be performed at known intervals rather than at arbitrary, variable, or more random intervals.

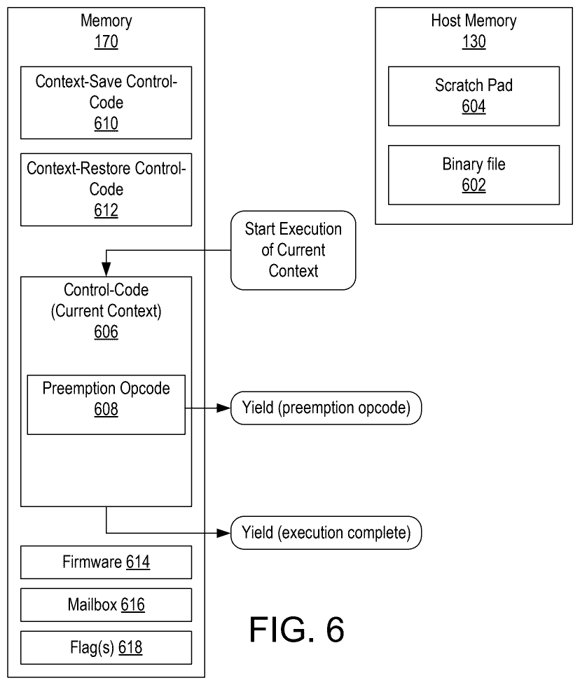

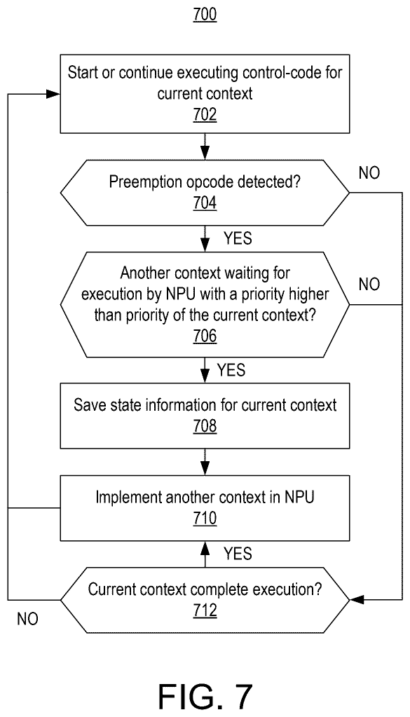

In one or more embodiments, compiler 350 inserts various default control-code routines within control-code 230. For example, context-save control-code and/or a context-restore control-code as discussed hereinbelow in connection with FIGS. 6 and 7 may be included in control-code 230 by compiler 350. In one or more other embodiments, settings of compiler 350 may be adjusted to override inclusion of one or more default routines and replace such routines with one or more user-specified or customized routines.

Conventional context switching solutions are hardware-based, interrupt driven solutions that save the processor register file of the processor that receives the interrupt. As generally known, a processor register file is a collection of registers (e.g., hardware registers) of a processor that temporarily store data. The register file reflects the current state of the processor itself. The inventive arrangements described herein implement a software-based solution that provides fine-grained control over the preemption process. In addition, the embodiments described herein do not save the register file for the processors. That is, no register file for cores 208 of compute tiles 202 is/are saved. Instead, contents of memory is saved as described hereinbelow as the preemption opcodes are inserted at locations where the particular state of cores 208, e.g., compute tiles 202, may be reflected in the contents of memory alone. That is, because the preemption opcodes are only inserted at points in the context where the relevant compute tiles are quiescent, only the contents of certain memory need be saved as opposed to saving contents of registers of the processor(s) or cores in this example.

It should be appreciated that context switching also may be performed at inferencing command boundaries (e.g., between contexts when a context completes execution). If, for example, there is only one layer in the control-code that completes execution within the enumerated time constraints, there would be no need to preempt the context during execution. In cases where a context is longer (e.g., containing more than one layer), preemption opcodes may be inserted between the layers of the context to allow context switching to happen in the middle of one inferencing command (e.g., to preempt execution of the context).

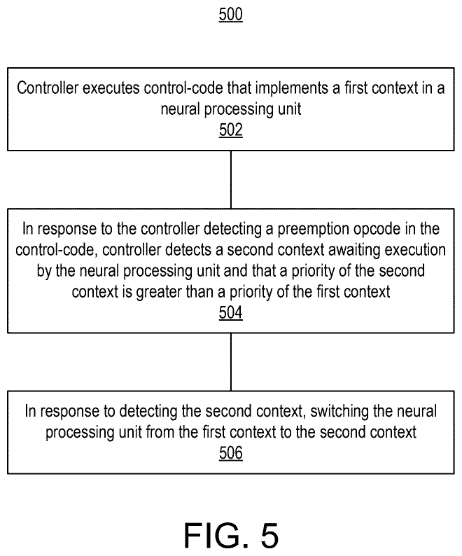

FIG. 5 illustrates a method 500 of preemption of contexts executed by an NPU in accordance with one or more embodiments of the disclosed technology. Method 500 may be performed by controller 160 in controlling NPU 150. In one or more embodiments, method 500 may be performed for NPU 150 as a whole, e.g., where the entirety of NPU 150 executes a same context and operates as a single partition. In one or more other embodiments, NPU 150 may be partitioned such that method 500 may be performed independently for each partition. For example, method 500 may be performed for partition 250 and/or for partition 252 (or other partition formations created in NPU 150) concurrently.

In block 502, controller 160 executes control-code 230, which implements a first context in NPU 150. Within this disclosure, the “first context” may also be referred to as the “current context” or the “preempted context.” As discussed, NPU 150 may be implemented as a data processing array, an example of which was described in connection with FIG. 2. NPU 150 is configured to provide deterministic performance. For example, NPU 150 is implemented with a data flow architecture and, as such, lacks an interrupt mechanism. Compute tiles 202 do not have interrupts to stop processing that is being performed.

In block 504, in response to controller 160 detecting a preemption opcode in control-code 230, controller 160 detects a second context awaiting execution by NPU 150 and that a priority of the second context is greater than a priority of the first context. In one or more embodiments, the controller 160 detects the preemption opcode by executing the preemption opcode. In block 506, in response to detecting the second context as described, controller 160 is capable of switching NPU 150 from the first context to the second context. That is, in block 506, controller 160 is capable of preempting the first context and implementing the second context.

The example of FIG. 5 illustrates that in response to encountering a preemption opcode in control-code 230 while executing a current context, controller 160 is capable of determining whether another higher priority context is waiting for execution. Further aspects of switching contexts in NPU 150 are described in greater detail hereinbelow in connection with FIGS. 6 and 7.

FIG. 6 illustrates certain operative features of preempting contexts in accordance with one or more embodiments of the disclosed technology. In the example of FIG. 6, host memory 130 includes a binary file (e.g., an XCLBIN file) 602 and scratch pad 604. Binary file 602 may include one or more PDIs. Each PDI may correspond to, or implement, one context. As discussed, a PDI may include control-code 230 that is executable by controller 160 and an NPU binary 360 that is executable by compute tiles 202 of NPU 150.

NPU binary 360 includes the executable program code (e.g., kernels) loaded into program memories 210 of compute tiles 202 that is executed by cores 208 to cause cores 208 to perform operations. Control-code 230 specifies a sequence of instructions executed by controller 160 that orchestrates execution of the context by NPU 150 or a partition thereof. Control-code 230 causes controller 160, for example, to program DMA circuits 214, 220, and/or 224 of NPU 150 to move data from global memory to memory tiles 206, from memory tiles 206 to data memories 212 (e.g., in compute tiles 202 to be operated on), and to move results generated by compute tiles 202 to memory tiles 206, and/or from memory tiles 206 to global memory. Control-code 230 is also capable of performing operations such as placing and/or releasing memory locks by writing to control registers in tiles (not shown) to facilitate shared memory among cores 208. Each core 208, in executing the program code of NPU binary 360, may behave like a worker thread in software that awaits work (e.g., data) as moved by controller 160 through execution of the sequence of instructions embodied as control-code 230.

For purposes of illustration, a PDI has been loaded in hardware accelerator 140 such that controller 160 is executing control-code 230 to implement (e.g., execute) a current context. Control-code 230 includes control-code 606 to implement the current context. In the example, the PDI that has been loaded may be obtained or extracted from binary file 602.

Control-code 606 includes a preemption opcode 608 that has been inserted therein by compiler 350. It should be appreciated that control-code 606 may include more than one preemption opcode inserted therein as previously described. In the example of FIG. 6, control-code 230 includes control-code 606, context-save control-code 610, and context-restore control-code 612. Context-save control-code 610 is capable of storing state information for a current context whose execution is being preempted. Context-restore control-code 612 is capable of implementing a context. Implementing a context includes restoring a context that was preempted. In one or more embodiments, context-restore control-code 612 is also capable of loading a context that was not preempted.

The example of FIG. 6 illustrates that execution of the current context by controller 160 yields in response to encountering or detecting preemption opcode 608. Execution of the current context by controller 160 also yields when execution is complete.

In one or more embodiments, controller 160 also may execute firmware 614. In one or more embodiments, firmware 614 may be embodied as or include an operating system. An example of an operating system that may be executed by controller 160 is a Real-Time Operating System (RTOS). As shown, memory 170 may include or implement a mailbox 616 that receives contexts (or requests for execution of contexts) from host processor 120. In one or more embodiments, context-restore control-code 612 is capable of detecting whether a context to be implemented was previously preempted. In one example, context-restore control-code 612 is capable of checking scratch pad 604 for the existence of state information for a context to be executed (e.g., a context detected in mailbox 616). The existence of state information for a context indicates that the context is a previously preempted context. A lack of state information for the context indicates that the context was not preempted and is starting execution anew. Alternatively, mailbox 616 may include an indication of whether the context was previously preempted, e.g., as part of the request. The context within mailbox 616, or the request, also may include or specify a priority for the context.

In one or more embodiments, firmware 614 is capable of comparing the priority of the context from the mailbox with a current context of NPU 150. In response to detecting that the priority of the context awaiting execution from mailbox 616 exceeds the priority of the current context, firmware 614 is capable of setting a flag 618. Operations such as monitoring mailbox 616, comparing priorities, and setting/clearing flags 618 may be performed in a separate thread of execution in controller 160 than execution of context(s) for NPU 150. Further operative features of the inventive arrangements are described hereinbelow in connection with FIG. 7.

FIG. 7 illustrates another method 700 of preemption of contexts executed by an NPU in accordance with one or more embodiments of the disclosed technology. Method 700 may be performed by controller 160 in controlling NPU 150. Method 700 may begin in a state where a PDI has been loaded into hardware accelerator 140 as illustrated in FIG. 6.

In one or more embodiments, method 700 may be performed for NPU 150 as a whole, e.g., where the entirety of NPU 150 executes a same context and operates as a single partition. In one or more other embodiments, NPU 150 may be partitioned such that method 700 may be performed independently for each partition. For example, method 700 may be performed for partition 250 and/or for partition 252 (or other partition formations created in NPU 150). In the latter case, method 700 is described only with respect to a single partition, but may be performed for a plurality of partitions in parallel.

In block 702, controller 160 starts or continues executing control-code 606 as the current or first context. Control-code 606 may represent a context being executed anew or from the start or may represent a restored context for which controller 160 is continuing execution. In block 702, in general, controller 160 continues executing control-code 606 for the current context until a preemption opcode is encountered (e.g., executed) or until the current context completes execution.

In block 704, controller 160 determines whether a preemption opcode, e.g., preemption opcode 608, has been detected or encountered. In response to detecting preemption opcode 608, method 700 continues to block 706. Otherwise, method 700 continues to block 712.

In block 706, controller 160 checks whether a second context having a higher priority than the priority of the first context is waiting for execution by NPU 150. A context having a higher priority than the priority of the current or first context is also referred to herein as the “higher priority context.” As discussed, firmware 614 is capable of setting a flag indicating whether the waiting context from mailbox 616 is a higher priority context. For example, controller 160, in response to detecting preemption opcode 608, is capable of yielding or pausing execution of the first context at least momentarily to check the status of flag(s) 618. In response to detecting that flag 618 is set, meaning that a higher priority context is waiting for execution, method 700 continues to block 708. In response to detecting that no flag is set, method 700 may loop back to block 702 to continue execution of the current context.

Continuing with block 708, in the case where a higher priority context is awaiting execution, as part of switching to execution of the higher priority context, state information for the current context is saved. For example, controller 160 is capable of executing context-save control-code 610. In executing context-save control-code 610, controller 160 is capable of storing a state, e.g., the current state of operation, of the first context as operation of the first context will be preempted, or interrupted, by the higher priority context. The state information is stored so that the state of the first context may later be restored when execution of the first context is resumed.

In one or more embodiments, the state of the first context includes a value of the program counter of controller 160 at the time the first context is preempted and the contents of certain memories of NPU 150 or the contents of certain memories of a partition of NPU 150 that is executing the first context being preempted. In one or more embodiments, the contents of any memory tiles 206 used in executing the first context are saved to scratch pad 604 in host memory 130. For example, DMA circuits 224 of interface tiles 204 are capable of reading data from memory tiles 206 and storing the data (e.g., state information for the current context) in scratch pad 604. The data may be stored with an indication of the context that was preempted.

For purposes of illustration, consider the case where the entirety of NPU 150 is executing the first context. In that case, the contents of each of memory tiles 206-1, 206-2, 206-3, 206-4, and 206-5 are stored in scratch pad 604 in host memory 130. In one or more embodiments, only the contents of each such memory tile 206 are stored in scratch pad 604. Controller 160, by virtue of executing context-save control-code 610 for example, programs the DMA circuits 224 of one or more interface tiles 204 to copy content of the memory tiles 206 to scratch pad 604 in host memory 130. As part of storing the state of the current context, controller 160 is capable of storing the value of the current program counter in a designated location in memory 170. In one or more other embodiments, controller 160 is capable of storing the value of the current program counter in scratch pad 604. In either case, the value of the program counter stored specifies a location in the current context (e.g., control-code 606) where execution was stopped and will resume when the context is later restored.

In another example where the current context runs in a partition of NPU 150, e.g., partition 250, the contents of only the memory tiles 206 in that partition are stored. In this example, the contents of only memory tiles 206-1 and 206-2 are stored in scratch pad 604 by one or more DMA circuits 224 of one or more memory tiles 204. In one or more embodiments, only the contents of each such memory tile 206 are stored in scratch pad 604. Still, controller 160 stores the value of the current program counter as described.

In one or more embodiments, host processor 120 is capable of executing a driver. The driver may be a kernel mode driver. The driver is capable of managing context save locations (e.g., in scratch pad 604) for each of the contexts that may be saved.

It should be appreciated that the number of DMA circuit 224 (and interface tiles 204) needed to convey data to scratch pad 604 may depend on the connectivity between interface tiles 204 and memory tiles 206 and/or bandwidth requirements. That is, in some cases, one interface tile 204 may access one, two, or three different columns and thus access up to three different memory tiles 206. In other cases, more interface tiles 204 may be devoted to storing state information to increase the bandwidth available for storing state information of the preempted context. For example, one interface tile 204 (e.g., one DMA circuit 224) per column of tiles of NPU 150 may be used or in other examples two interface tiles (e.g., two DMA circuits 224) may be used for a single column of tiles of NPU 150. The particular number of DMA circuits 224 and/or memory tiles 204 used to store state of memory tiles 206 is not intended as a limitation of the inventive arrangements.

In block 710, a second, or different, context is implemented in NPU 150. In implementing block 710 when coming from block 708, the second context to be implemented is a higher priority context that is preempting execution of the current or first context. In this example, the higher priority context, being different from the current context, may be a context that was not previously preempted or may be a context that was previously preempted. In either case, controller 160, as part of block 710, is capable of clearing or resetting NPU 150, or the relevant partition of NPU 150. For example, controller 160 may clear compute tiles 202 (e.g., program memories 210, data memories 212, and DMA circuits 214), memory tiles 206 (e.g., memories 218, DMA circuits 220), and interface tiles (e.g., DMA circuits 224). In certain embodiments, the stream interconnects 216 of the respective tiles also may be cleared.

In the case of where the second context was not previously preempted, controller 160, in executing context-restore control-code 612, is capable of loading a PDI for the second context to be executed. Controller 160 may execute context-restore control-code 612 to extract control-code (e.g., control-code) for the second context and an NPU binary for the second context from the PDI. Controller 160, for example, may store the control-code for the second binary in 170 for execution and load the NPU binary into NPU 150, which loads program code into program memories 210 for execution by cores 208. Controller 160 may begin executing the control-code for the second context from a starting address of the control-code (e.g., with the program counter set to the starting address of the control-code for the context).

In the case where the second context is a previously preempted context, controller 160, in executing context-restore control-code 612, performs substantially the same operations. In the case of restoring a previously preempted context, controller 160 restores the state information for the second context from scratch pad 604 to NPU 150 or partition thereof. That is, controller 160 fetches the state information for the second context from host memory 170 and loads the state information into the appropriate memory tiles 202 (e.g., the memory tiles 202 from which the content was originally stored or preserved). Once the state information is restored, controller 160 may load the previously stored program counter value into the program counter and jump to the appropriate location in the control-code for the second context and begin or continue execution of the control-code from the point at which the second context was previously preempted.

It should be appreciated that as the second context is executed by controller 160, the second context is considered the “current” or “first” context for purposes of continuing or iterating through blocks of method 700.

Continuing with block 712, in the case where no preemption opcode was detected or encountered, controller 160 determines whether the current context has competed execution. For example, controller 160 continues execution with the next opcode immediately following preemption opcode 608 (e.g., in the case where another context with a higher priority than the current context was not detected in block 706). In response to determining that the current context has completed execution, method 700 continues to block 710. In response to determining that the current context has not completed execution, method 700 may loop back to block 702 and continue execution of the control-code of for the current context.

In continuing to block 710 from block 712, the second context to be implemented may or may not have a higher priority than the current context that finished execution. Block 710 may be implemented as the second context in this case may be one that was previously preempted or not.

In the example embodiments described herein, the NPU binary executed by cores 208 of compute tiles 202 (e.g., from program memories 210) and the application executing in host system 110 that initiates processing of NPU 150 (e.g., the various contexts executed by NPU 150) are unaware of any preemption taking place. This means that same NPU binary that is executed by compute tiles 202 may be used both with and without preemption as described herein. Similarly, the application executed by host system 110 need not be modified to utilize preemption as described herein. The entire preemption, saving of state information, and subsequent restoration of a context is transparent with respect to the operation of compute tiles 202 and the application executed by host system 110.

In one or more embodiments, the state information for a context may be expanded beyond only storing content of memory tiles 202 and the program counter value. For example, the state information for a context may include only the content of each memory tile 206 used in executing the current context, the program counter value of controller 160, and the content of each data memory 212 of a compute tile 202 used to execute the context. Thus, the state information, as stored and restored, for a context will include the aforementioned memories for each memory tile 206 and each compute tile 202 of the entire NPU 150 or the particular partition that executes the context being preempted. In such embodiments, preemption opcodes may be inserted in locations of control-code in addition to or other than TCT boundaries since encapsulation of state in memory tiles 206 is not necessary.

Within this disclosure, the term “only” is intended emphasis that the state information of a context includes only data from the memory or memories described herein and excludes or omits the register file of each core 208 of the NPU 150 or of the partition executing the context being preempted.

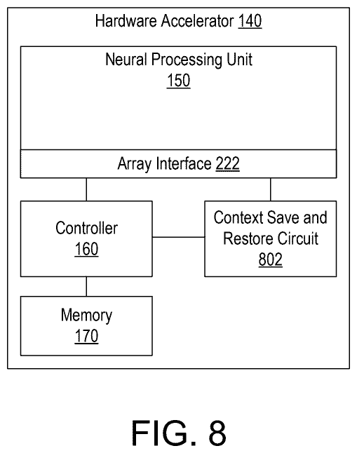

FIG. 8 illustrates another implementation of hardware accelerator 140 in accordance with one or more embodiments of the disclosed technology. In the example of FIG. 8, certain software-based operations performed by controller 160 are hardened. That is, particular functions such as those performed by context-save control-code 610 and/or context-restore control-code 612 may be implemented as a dedicated and hardened circuit block illustrated as context save and restore circuit 802.

In the example of FIG. 8, in response to controller 160 detecting (e.g., executing) a preemption opcode in the control-code, controller 160 generates a signal or message to context save and restore circuit 802. The message may indicate causes context save and restore circuit 802 to perform the functions previously attributed to context-save control-code 610 and context-restore control-code 612. The message further may specify the particular partition that is being preempted.

By hardening these operations, hardware accelerator 140 may switch contexts in NPU 150 faster and with less latency. Further, as controller 160 may be executing multiple contexts for multiple partitions of NPU 150 (e.g., in a multi-threaded manner), controller 160 is relieved of performing these functions. In this regard, controller 160 is provided with an “interrupt service” from context save and restore circuit 802.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise. As defined herein, the terms “at least one,” “one or more,” and “and/or,” are open-ended expressions that are both conjunctive and disjunctive in operation unless explicitly stated otherwise. As defined herein, the term “automatically” means without human intervention. As defined herein, the term “user” refers to a human being.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “real-time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the inventive arrangements described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the inventive arrangements described herein may be assembler instructions, instruction-set-architecture (ISA) instructions, machine instructions, machine dependent instructions, microcode, control-code instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various embodiments of the disclosed technology have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
executing, by a controller, control-code that implements a first context in a neural processing unit;
in response to the controller detecting a preemption opcode in the control-code, detecting, by the controller, a second context awaiting execution by the neural processing unit and that a priority of the second context is greater than a priority of the first context; and
in response to the detecting of the second context, switching, by the controller, the neural processing unit from the first context to the second context.

2. The method of claim 1, wherein the preemption opcode is located within the control-code at a location in which compute tiles of the neural processing unit are in a quiescent state.

3. The method of claim 2, wherein the preemption opcode is located between two consecutive layers of the first context.

4. The method of claim 1, wherein the switching from the first context to the second context comprises:
saving a state of the first context by saving a value of a program counter of the controller and saving content from a memory of the neural processing unit.

5. The method of claim 4, wherein the memory of the neural processing unit includes one or more memory tiles.

6. The method of claim 4, wherein the memory of the neural processing unit includes one or more memory tiles and one or more data memories of one or more compute tiles.

7. The method of claim 4, wherein the switching from the first context to the second context comprises:
restoring a state of the second context by:
loading a neural processing unit binary for the second context into compute tiles of the neural processing unit;
loading saved content for the second context into the memory of the neural processing unit and loading a saved program counter value for the second context into the program counter of the controller;
loading control-code for the second context in a program memory of the controller; and
continuing execution of the control-code for the second context from a location specified by the saved program counter value.

8. The method of claim 7, wherein the loading the saved content into the memory of the neural processing unit includes loading the saved content into one or more memory tiles.

9. The method of claim 7, wherein the loading the saved content into the memory of the neural processing unit includes loading the saved content into one or more memory tiles and one or more data memories of one or more compute tiles.

10. The method of claim 1, further comprising:
comparing the priority of the first context with the priority of the second context.

11. The method of claim 1, wherein the neural processing unit is implemented using a data flow architecture to provide deterministic performance.

12. A system, comprising:
a neural processing unit; and
a controller coupled to the neural processing unit;
wherein the controller is capable of executing control-code that implements a first context in the neural processing unit;
wherein the controller, in response to detecting a preemption opcode in the control-code, is capable of detecting a second context awaiting execution by the neural processing unit and that a priority of the second context is greater than a priority of the first context; and
wherein in response to the detecting, the controller is capable of switching the neural processing unit from the first context to the second context.

13. The system of claim 12, wherein, in response to detecting that no other context having a higher priority than the priority of the first context is awaiting execution by the neural processing unit, the controller continues execution of the first context.

14. The system of claim 12, wherein the preemption opcode is located within the control-code at a location in which compute tiles of the neural processing unit are in a quiescent state.

15. The system of claim 14, wherein the preemption opcode is located between two consecutive layers of the first context.

16. The system of claim 12, wherein the controller is capable of switching from the first context to the second context by:
saving a state of the first context by saving a value of a program counter of the controller and saving content from a memory of the neural processing unit.

17. The system of claim 16, wherein the memory of the neural processing unit includes one or more memory tiles.

18. The system of claim 16, wherein the memory of the neural processing unit includes one or more memory tiles and one or more data memories of one or more compute tiles.

19. The system of claim 16, wherein the switching from the first context to the second context comprises:
restoring a state of the second context by:
loading saved content for the second context into the memory of the neural processing unit and loading a saved program counter value for the second context into the program counter of the controller;
loading configuration data for the second context into compute tiles of the neural processing unit;
loading control-code for the second context in a program memory of the controller; and
continuing execution of the control-code for the second context from a location specified by the saved program counter value.

20. The system of claim 19, wherein the loading the saved content into the memory of the neural processing unit includes loading the saved content into one or more memory tiles.
